(19) United States
(12) Patent Application Publication
(10) Pub. No.: US 2006/0275032 A1
(43) Pub. Date: Dec. 7, 2006

(54) Actuator for mobile terminal

(75) Inventors: Goo Hong, Ansan-si (KR); Sung-Hoon Kim, Suwon-si (KR); Jang-Young Im, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/444,318

(22) Filed: Jun. 1, 2006

(30) Foreign Application Priority Data
Jun. 2, 2005 (KR) 10-2005-0047170

(51) Int. Cl. G03B 17/00

(52) U.S. Cl. 396/439

(57) ABSTRACT

An actuator for a mobile terminal using suspension wires is disclosed. By using an actuator for a mobile terminal comprising a holder, magnets mounted inside the holder, a coil mounted inside the holder and positioned on the inside of the magnets, a bobbin joined with the coil and having a lens in its center, and suspension wires, the ends of which are joined to the holder, bent at a particular angle to elastically press the bobbin, the manufacturing process may be simplified and the manufacturing cost may be reduced.

### CROSS-REFERENCE TO RELATED APPLICATIONS

This application claims the benefit of Korean Patent Application No. 2005-47170 filed with the Korea Industrial Property Office on Jun. 2, 2005, the disclosure of which is incorporated herein by reference.

### BACKGROUND

1. Technical Field

The present invention relates to an actuator for a mobile terminal.

2. Description of the Related Art

Camera modules for mobile terminals are trending towards higher resolutions and more sophisticated functionalities, with advances in technology allowing functions comparable to regular high-end digital cameras. In particular, various attempts are being made to implement auto-focusing technology on the scale of a mobile terminal. The mainstream of these attempts involves the voice coil motor (VCM) type actuator.

A VCM type actuator, as shown in FIG. 2, performs auto-focusing by operating the operation part (not shown) by means of the electromagnetic force generated from the interaction between the magnetic field generated by the magnets 15 and the electrical field generated by the coil 17. Also, the VCM type actuator uses the flat spring 11 shown in FIG. 1 to support the operation part and adjusts the degree of focusing for the operation part.

To obtain an acceptable level of performance by improving the sensitivity in a conventional actuator for a mobile terminal, the flat spring 11 must be manufactured to have a complex shape such as that shown in FIG. 1, with a thickness below 0.1 mm. Thus, it is difficult to manufacture such a flat spring 11 having a complex shape and low thickness, and the production cost is high as well. Also, to supply a current via the flat spring 11 to the coil 17, it is necessary to connect the end of the coil 17 to the flat spring 11 for assembly, and this assembly process is highly complicated and time-consuming.

Further, the circular magnets 15 used in the conventional actuator for a mobile terminal is expensive, and its manufacture is difficult. Moreover, the magnetic efficiency of the circular magnets 15 is low, due to its geometric characteristics.

### SUMMARY

To overcome the foregoing problems, an aspect of the invention provides an actuator for a mobile terminal which uses suspension wires instead of the conventional flat spring, so that the manufacturing process may be simplified and the manufacturing cost may be reduced.

Another aspect of the invention provides an actuator for a mobile terminal which provides greater convenience in manufacture, as the suspension wires and coil may easily be connected.

Yet another aspect of the invention provides an actuator for a mobile terminal which provides high magnetic efficiency and low manufacturing cost, as quadrilateral magnets are used.

Additional aspects and advantages of the present general inventive concept will be set forth in part in the description which follows and, in part, will be obvious from the description, or may be learned by practice of the general inventive concept.

An actuator for a mobile terminal according to an embodiment of the present invention may comprise a holder, magnets mounted inside the holder, a coil mounted inside the holder and positioned on the inside of the magnets, a bobbin joined with the coil and having a lens in its center, and suspension wires, the ends of which are joined to the holder, bent at a particular angle to elastically press the bobbin.

An actuator for a mobile terminal according to an embodiment of the invention uses suspension wires instead of the conventional flat spring, so that the manufacturing process may be simplified and the manufacturing cost may be reduced.

By forming the magnets as quadrilateral magnets arranged inside the holder in a polygonal shape, the magnetic efficiency increased, and also the manufacturing cost is reduced.

An actuator for a mobile terminal according to another embodiment of the invention further comprises outer yokes mounted inside the holder and arranged in a polygonal shape, and inner yokes positioned with a constant amount of displacement from the outer yokes and arranged in a polygonal shape in correspondence with the outer yokes, where the magnets and the coil are positioned between the outer yokes and the inner yokes.

The actuator for a mobile terminal comprised as above can concentrate the magnetic force generated by the magnets on the coil, to further increase the operating power of the bobbin.

In an actuator for a mobile terminal according to another embodiment of the invention, the holder has a holder PCB, and the bobbin has a bobbin PCB connected with the coil, where the holder PCB is joined with one end of the suspension wire, and the bobbin PCB is joined with the other end of the suspension wire.

In an actuator for a mobile terminal according to another embodiment of the invention, the holder may have a holder PCB, and the bobbin may have a bobbin PCB connected with the coil, where the holder PCB may be joined with one end of the suspension wire, and the bobbin PCB may be joined with the other end of the suspension wire. Also, the holder may have a holder PCB, and the bobbin may have a barrel holder connected with the coil, where the holder PCB may be joined with one end of the suspension wire, and the barrel holder may be joined with the other end of the suspension wire. The suspension wires may be joined with the barrel holder by dipping.

Thus, by connecting both ends of the suspension wire to the holder PCB, to which an electric current is supplied from an outside source, and to the bobbin PCB or the barrel holder connected to the coil, the suspension wires, PCB, and coil may readily be joined together.

By forming the holder PCB to be elastically deformable, the sensitivity of the suspension wires may be improved. Also, the holder PCB may comprise a binding part joined with the holder, arms extending from both ends of the binding part in a particular length, and an insertion part formed on one end of the arm, where one end of the suspension wire may be inserted into the insertion part and secured. The sensitivity of the suspension wire may further be improved, when the holder PCB is additionally equipped with arms having elasticity.

Forming the insertion part as a slot having a particular length or as a groove open upwards not only provides a clearance for the movement of the suspension wires but also allows easier attaching of the suspension wires.

The holder PCB may have an insertion part for securing one end of the suspension wire and may be attached to the perimeter of the holder or be positioned inside the holder.

Preferably, the suspension wires may be positioned in bilateral symmetry with respect to the bobbin. For example, the suspension wires may be positioned in an “11”, a trapezoidal, an “X”, or an “XX” formation, etc. Here, portions of the suspension wire which do not require the flow of electricity may be bonded to simplify the production process.

The holder may have a quadrilateral shape, and the outer yokes and the inner yokes may be arranged in a quadrilateral shape in correspondence with the shape of the holder.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a flat spring used in a conventional actuator.

FIG. 2 is a perspective view of a magnetic operation part in a conventional actuator.

FIG. 3 is an assembled perspective view of an actuator for a mobile terminal with an upper case removed, according to an embodiment of the invention.

FIG. 4 is an exploded perspective view of an actuator for a mobile terminal according to an embodiment of the invention.

FIG. 5 is a front elevation view of an actuator for a mobile terminal according to an embodiment of the invention.

FIG. 6 is a plan view of an actuator for a mobile terminal with an upper case and a bobbin removed, according to an embodiment of the invention.

FIG. 7 is a perspective view of an actuator for a mobile terminal according to another embodiment of the invention.

FIG. 8a is a schematic diagram illustrating suspension wires positioned in a trapezoidal formation.

FIG. 8b is a schematic diagram illustrating the suspension wires of FIG. 8a with portions of the wires bonded, according to an embodiment of the invention.

FIG. 9 is a graph representing the up/down spring coefficient and left/right spring coefficient of suspension wires positioned in a trapezoidal formation.

FIG. 10a is a schematic diagram illustrating suspension wires positioned in a straight-line formation, according to another embodiment of the invention.

FIG. 10b is a schematic diagram illustrating the suspension wires of FIG. 10a with portions of the wires bonded.

FIG. 11a is a schematic diagram illustrating suspension wires positioned in a “><” formation, according to another embodiment of the invention.

FIG. 11b is a schematic diagram illustrating the suspension wires of FIG. 11a with portions of the wires bonded.

FIG. 12 is a graph representing the up/down spring coefficient and left/right spring coefficient of suspension wires positioned as in FIG. 11a.

FIG. 13a is a schematic diagram illustrating suspension wires positioned in an “X” formation, according to still another embodiment of the invention.

FIG. 13b is a schematic diagram illustrating the suspension wires of FIG. 13a with portions of the wires bonded.

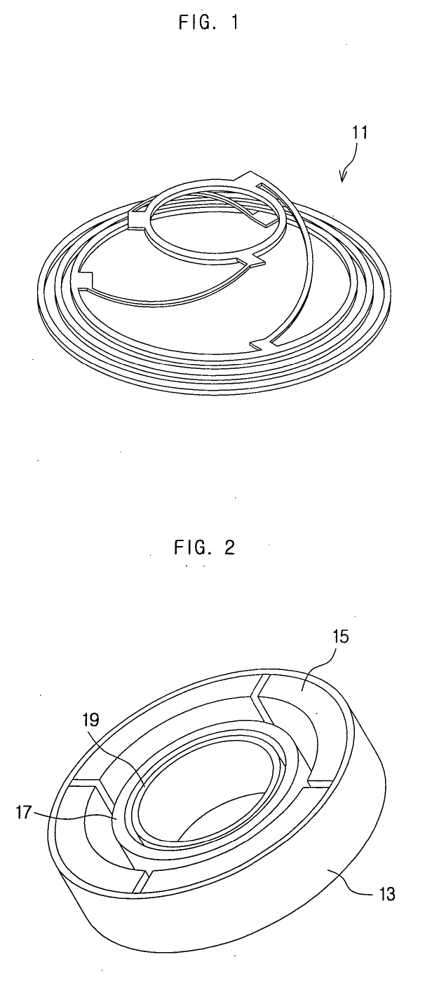

### DETAILED DESCRIPTION

Hereinafter, embodiments of the actuator for a mobile terminal according to the present invention will be described in more detail with reference to the accompanying drawings.

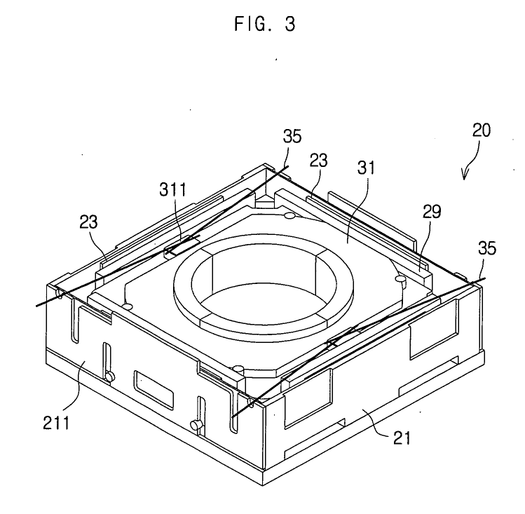

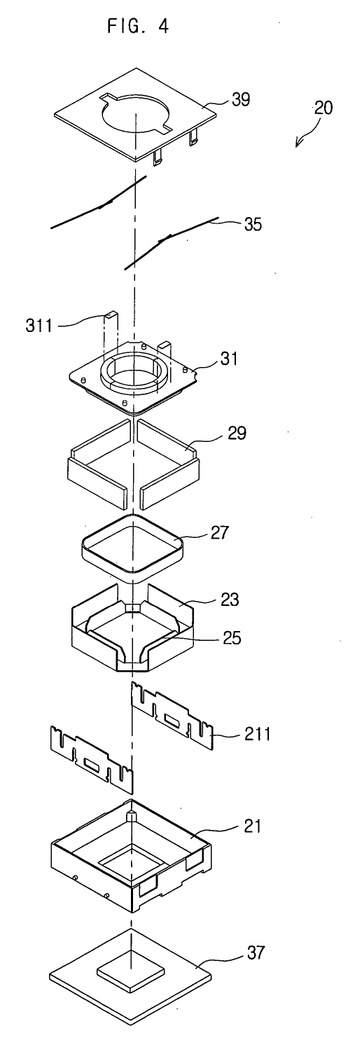

FIG. 3 is a perspective view of an actuator for a mobile terminal illustrating its assembled state according to an embodiment of the invention, and FIG. 4 is an exploded perspective view of the actuator for a mobile terminal in FIG. 3. Referring to FIGS. 3 and 4, an actuator for a mobile terminal according to the present invention comprises a holder 21, outer yokes 23 and inner yokes 25 mounted inside the holder 21, a coil 27 positioned between the outer yokes 23 and the inner yokes 25, a bobbin 31 joined with the coil and having a lens (not shown) in its center, and suspension wires 35, the ends of which are joined with the holder 21, bent at a particular angle to press the bobbin 31.

As shown in FIGS. 3 and 4, the holder 21 has a certain space inside and has a shape of a rectangular hexahedron with an open top. The outer yokes 23, inner yokes 25, coil 27, magnets 29, and bobbin 31 are housed inside the holder 21. The bottom surface of the holder 21 is in contact with the bottom surface of the bobbin 31. An upper case 39 and a lower case 37 are joined respectively to the upper and lower portions of the holder 21. The suspension wires 35 may be connected directly to the sides facing each other on the holder 21, or holder PCB's 211 may additionally be included with the suspension wires joined to the holder PCB's 211.

The holder PCB's 211 each join to the sides facing each other on the holder 21. Since the holder PCB's 211 are formed from an elastic material such as FR-4, the sensitivity of the suspension wires 35 is improved. Circuit patterns are formed on the holder PCB 211, as shown in FIG. 6, through which an electric current supplied from an outside source is supplied to the suspension wires 35.

The holder PCB 211 comprises a binding part 211a touching the holder 21, arms 211b extending from both ends of the binding part 211a in a particular length, and an insertion part 211c formed on one end of the arm.

The arms 211b extend from both ends of the binding part 211a in bilateral symmetry, where the shape and length of the arms 211b may be adjusted to achieve the desired sensitivity of the suspension wires 35. Various shapes may be used for the arms 211b that are able to provide elastic force to the insertion parts 211c. For example, the arms 211b may also be shaped as an “M” or an “N”.

The insertion parts 211c are slot or are grooves open upwards, formed on the ends of the arms 211b. The suspension wires 35 are inserted and soldered to the insertion parts 211c. Forming the insertion parts 211c as slots having a particular length in the vertical direction or as grooves open upwards, not only provides a clearance for the movement of the suspension wires 35 during assembly, but also allows easier joining of the suspension wires.

The outer yokes 23 and the inner yokes 25 are mounted inside the holder 21, and the coil 27 and the magnets 29 are positioned within the space between the outer yokes 23 and the inner yokes 25. The outer yokes 23 and the inner yokes 25 act to increase the magnetic efficiency by concentrating the magnetic field generated by the magnets 29 on the coil 27. The outer yokes 23 and the inner yokes 25 may be omitted as necessary.

The outer yokes 23 are arranged in a polygonal shape in correspondence to the shape of the holder 21. The magnets 29 are attached to the inner sides of the outer yokes 23. The inner yokes 25 are positioned with a constant amount of displacement from the outer yokes 23, and are arranged in a polygonal shape in correspondence to the shape of the outer yokes 23. It may be preferable for the outer yokes 23 and the inner yokes 25 to be formed of iron (Fe), SPCC, or nickel (Ni), etc., which have superior magnetic permeability characteristics.

The coil 27 is positioned between the magnets 29 and the inner yokes 25 and is mounted on the bobbin 31. The coil 27 generates an electrical field by means of the electric current supplied through the holder PCB's 211 and the suspension wires 35. The magnetic field generated by the magnets 29 permeates through the coil 27, and the coil 27 and the bobbin joined thereto are made to operate by the electromagnetic force due to the interaction between the magnetic field and the electrical field.

The magnets 29 are each mounted on the inner surfaces of the outer yokes 23. Circular magnets or quadrilateral magnets may be used for the magnets 29. The quadrilateral magnets have the advantages of lower cost, lower defective rate, as well as superior magnetic properties.

The bobbin 31 is joined with the coil 27, and is made to operate by means of the electromagnetic force generated by the interaction between the coil 27 and the magnet 29. A lens module (not shown) is mounted in the center of the bobbin 31. The bobbin 31 is pressed by the suspension wires 35 to touch the bottom surface of either the holder or the yoke, where the position of the bobbin 31 may be a reference point for the lens. When a particular level of electric current is supplied to the coil 27, the focus of the lens on the bobbin 31 may be adjusted due to the balance between the suspension wires 35 and the electromagnetic force.

Bobbin PCB's 311 are formed on the upper surface of the bobbin 31, and the bobbin PCB's 311 are connected with the coil 27. Also, one end of each of the suspension wires 35 is connected with the bobbin PCB 311. Thus, the electric currents supplied through the suspension wires 35 flow through the bobbin PCB's 311 to the coil 27. Of course, the suspension wires 35 and the coil 27 may be connected directly, but the connection process may be made easier by using the bobbin PCB's 311.

The bobbin PCB's 311 may be formed on any position on the bobbin 31, depending on the lengths and formation of the suspension wires 35. For instance, they may be formed along the perimeter of the lens module binding part 311, as shown in FIG. 3, or may be formed respectively on the edge parts of the bobbin 31. The bobbin PCB 311 is joined with an end of the suspension wire 35 by soldering. However, the end of the suspension wire may also be bonded with the bobbin PCB 311, when electrical joining by means of soldering is not required.

A plurality of suspension wires 35 are positioned in bilateral symmetry on the upper portion of the bobbin 31. One end of each of the suspension wires 35 is joined with the holder 21 or with the holder PCB 211 joined to the holder 21, while the other end is joined with the bobbin PCB 311 or with the barrel holder 41. Both ends of each of the suspension wires 35 are soldered or bonded.

Any material having elasticity may be used for the suspension wires 35. For example, wires formed from beryllium copper or brass alloys may be used. If the thickness of the suspension wires 35 is thin, a superior sensitivity may be obtained, but there is a greater risk of tilting or sagging when the bobbin 31 is shaken left and right. On the other hand, if the suspension wires 35 are thick, more force is required to operate the bobbin 31, and the sensitivity is decreased. Thus, the diameter of the suspension wires 35 may vary according to the size and performance of the bobbin.

Sensitivity is defined by Equation 1, where k is the spring coefficient of the suspension wires 35, and F is the electromagnetic force applied by the coil 27, etc.

$${S}_{L} = \frac{F}{k} \qquad Equation 1$$

As seen in Equation 1, sensitivity represents the degree of change due to force F, and the lower the k value of the suspension wires 35, the greater the sensitivity, so that the displacement of the bobbin 31 may be increased with only a small force.

The suspension wires 35 are bent at a particular angle to press the bobbin 31, whereby the bobbin 31 maintains its reference position by keeping in contact with the holder 21. Methods of bending the suspension wires 35 may include first securing all of the parts besides the joined body of the bobbin 31 and the coil 27 and then moving the bobbin 31 upwards, or first securing the joined body of the bobbin 31 and coil 27 and then moving the holder 21 downwards. In such manner, the suspension wires 35 are bent into a “∩” shape. By adjusting the balance between the elastic pressing force due to the suspension wires 35 and the electromagnetic force generated by the coil 27, the lens module (not shown) mounted on the bobbin 31 is made to operate.

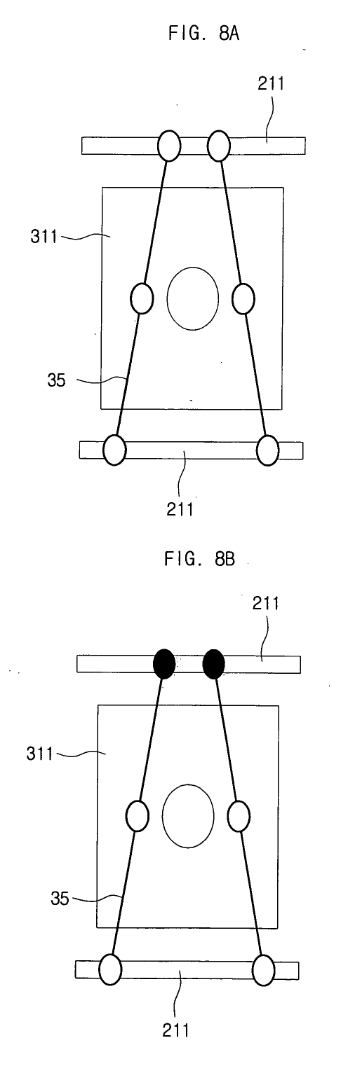

The elastic pressing force due to the suspension wires 35 not only depends on the thickness of the wires but also depends greatly on the formation of the wires. This will be explained hereinafter with reference to FIGS. 8a to 13b.

FIG. 6 is a plan view illustrating the interior composition of an actuator for a mobile terminal according to an embodiment of the invention.

The outer yokes 23 and inner yokes 25 are positioned inside the holder 21. The magnets 29 are attached respectively to the inner surfaces of the outer yokes 23, and the coil 27 is positioned between the magnets 29 and the inner yokes 25. Although it is not shown in the figures, the coil 27 may also be positioned on the upper surface of the magnets 29 positioned between the inner yokes 23 and outer yokes 25.

The coil 27 joins with the bobbin 31 to consist an operation part. The bobbin 31 is pressed by the suspension wires 35 to touch the holder 21 or the yoke, and vibrates to adjust the focus of the lens when an electric current is supplied. The focus of the lens is adjusted by means of the balance between the pressing force of the suspension wires 35 and the electromagnetic force generated by the coil 27 and the magnet 29.

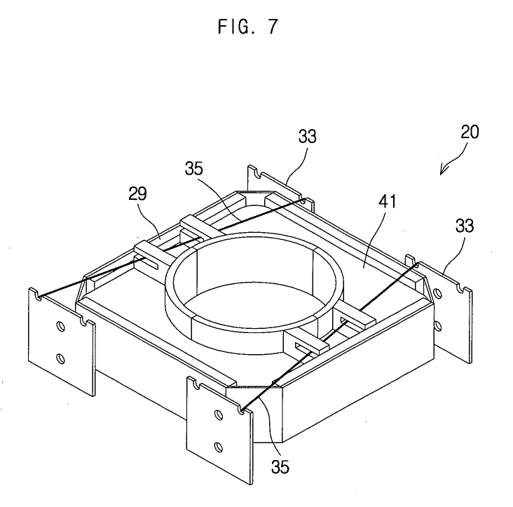

FIG. 7 is a perspective view of an actuator for a mobile terminal according to another embodiment of the invention. The actuator for a mobile terminal illustrated in FIG. 7 has a barrel holder 41 joining with the upper surface of the bobbin 31.

The barrel holder 41 is connected with the coil 27, and one end of each of the suspension wires 35 is connected with the barrel holder 41. Thus, the electric current is supplied to the coil 27 through the suspension wires 35 and the barrel holder 41. By using the barrel holder 41, the coil 27 and the suspension wires 35 may readily be connected by dipping. Dipping refers to a process of dipping the coil 27 in a container filled with molten lead and removing the coil's covering to naturally leave a lead coating.

FIGS. 8a and 8b are schematic diagrams illustrating a formation of the suspension wires according to an embodiment of the invention. The suspension wires 35 in FIGS. 8a and 8b are positioned in a trapezoidal formation.

In FIG. 8a, both ends of the suspension wire 35 are soldered to the holder PCB's 211, with a particular position at the center of the suspension wire 35 soldered to the bobbin PCB 311. For the suspension wire 35 illustrated in FIG. 8b, one end is soldered, and the other end is bonded (hereinafter represented with black coloring). This is because soldering only the two ends of the suspension wires 35 still allows the inflow and outflow of the electric current supplied to the coil 27.

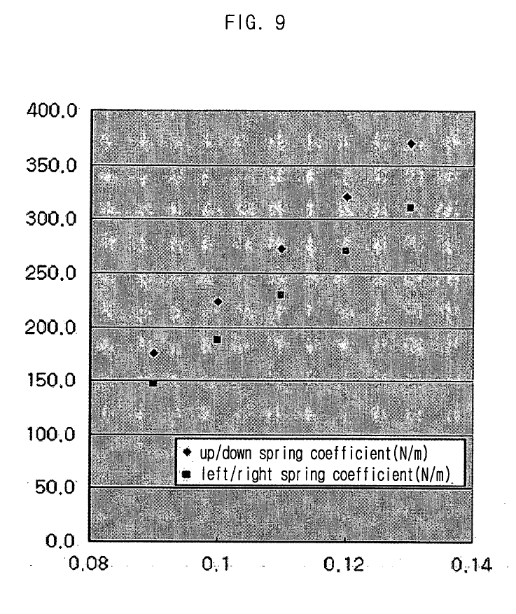

FIG. 9 is a graph representing the up/down spring coefficient and left/right spring coefficient with respect to thickness for suspension wires 35 positioned as in FIGS. 8a and 8b. Here, the up/down spring coefficient represents the spring coefficient of the suspension wires 35 regarding the vibration of the bobbin 31 in the up/down directions, and the left/right spring coefficient represents the spring coefficient of the suspension wires 35 regarding the left/right operation of the bobbin 31.

The up/down spring coefficient and the left/right spring coefficient of suspension wires 35 positioned as in FIGS. 8a and 8b are listed below in Table 1.

TABLE 1

| | diameter (mm) | | | | |
|---|---|---|---|---|---|
| | 0.09 | 0.1 | 0.11 | 0.12 | 0.13 |
| up/down spring coefficient (N/m) | 175.4 | 224.0 | 272.6 | 321.3 | 369.9 |
| left/right spring coefficient (N/m) | 147.0 | 188.2 | 229.1 | 270.0 | 310.8 |

As seen in FIG. 9 and Table 1, the up/down spring coefficient and left/right spring coefficient increase with an increase in diameter of the wires. Therefore, referring to Equation 1, it is seen that the sensitivity of the actuator for a mobile terminal decreases with an increase in the wire thickness. The decrease in sensitivity means a large force is required for the operation of the bobbin 31. This becomes a cause of increased power consumption.

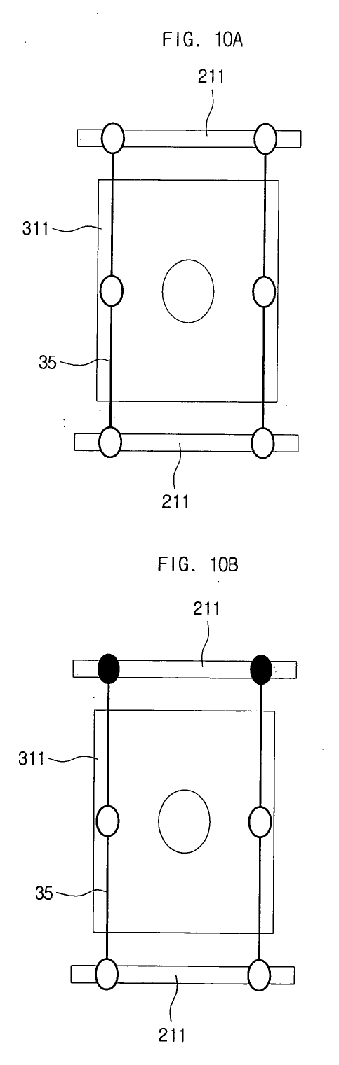

FIGS. 10a and 10b are schematic diagrams illustrating a formation of the suspension wires 35 according to another embodiment of the invention. The suspension wires 35 in FIGS. 10a and 10b are positioned in an “11” formation.

In FIG. 10a, both ends of the suspension wire 35 are soldered to the holder PCB's 211, with a particular position at the center of the suspension wire 35 soldered to the bobbin PCB 311. For the suspension wire 35 illustrated in FIG. 10b, one end is soldered, and the other end is bonded. This is because soldering only the two ends of the suspension wires 35 still allows the inflow and outflow of the electric current supplied to the coil 27.

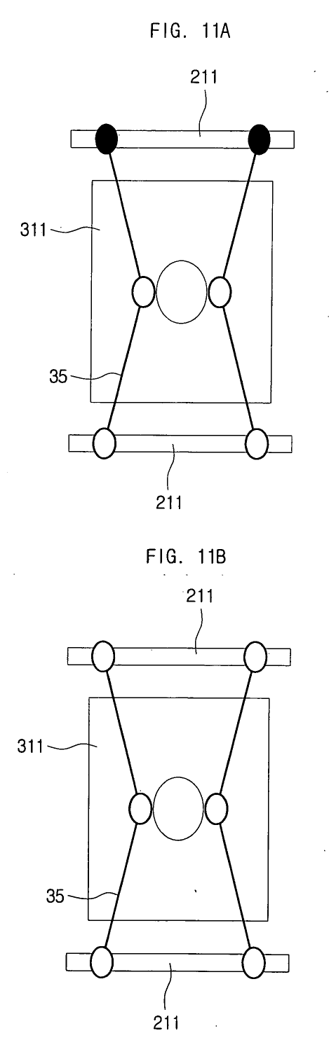

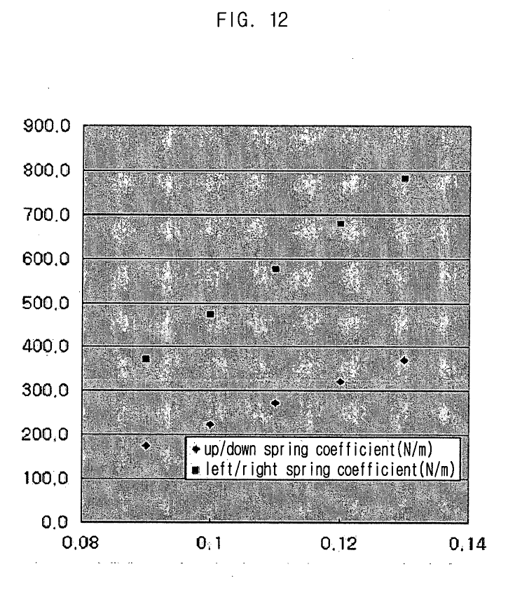

FIGS. 11a and 11b are schematic diagrams illustrating a formation of the suspension wires 35 according to another embodiment of the invention. The suspension wires 35 in FIGS. 10a and 10b are positioned in an “><” formation.

FIG. 12 is a graph representing the up/down spring coefficient and left/right spring coefficient of the suspension wires positioned as in FIGS. 11a and 11b. The up/down and left/right spring coefficient values with respect to wire thickness are listed in Table 2.

TABLE 2

| | diameter (mm) | | | | |
|---|---|---|---|---|---|
| | 0.09 | 0.1 | 0.11 | 0.12 | 0.13 |
| up/down spring coefficient (N/m) | 175.4 | 224.0 | 272.6 | 321.3 | 369.9 |
| left/right spring coefficient (N/m) | 370.0 | 473.6 | 576.4 | 679.2 | 782.0 |

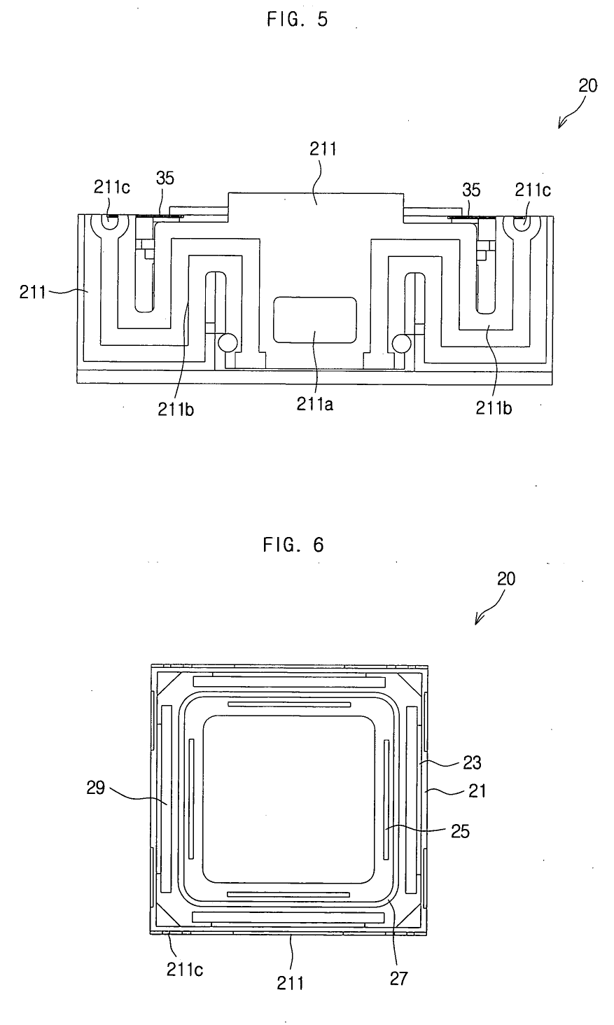

As seen in FIG. 12 and Table 2, the suspension wires 35 positioned as in FIGS. 11a and 11b, when compared with the suspension wires 35 positioned as in FIGS. 8a and 8b, have the same values for the up/down spring coefficient but much greater values for the left/right spring coefficient. Thus, the suspension wires positioned in a “><” formation as in FIGS. 11a and 11b are able to decrease tilting and sagging, since they have a greater left/right spring coefficient. The up/down and left/right spring coefficients of the suspension wires 35 with respect to diameter is listed below in Table 3, for the case where both ends of the suspension wire 35 in FIGS. 11a and 11b are secured to the holder PCB's 211 as illustrated in FIG. 5.

TABLE 3

| | | |
|---|---|---|
| diameter (mm) | 0.09 | 0.1 |
| up/down spring coefficient (N/m) | 138.5 | 192.0 |
| left/right spring coefficient (N/m) | 170.8 | 219.0 |

As seen in Table 3, when the suspension wires 35 are secured to the holder PCB's 211, the values of the up/down spring coefficient and the left/right spring coefficient are further decreased due to the elastic action of the holder PCB's 211. Thus, the sensitivity of the actuator for a mobile terminal may further be increased.

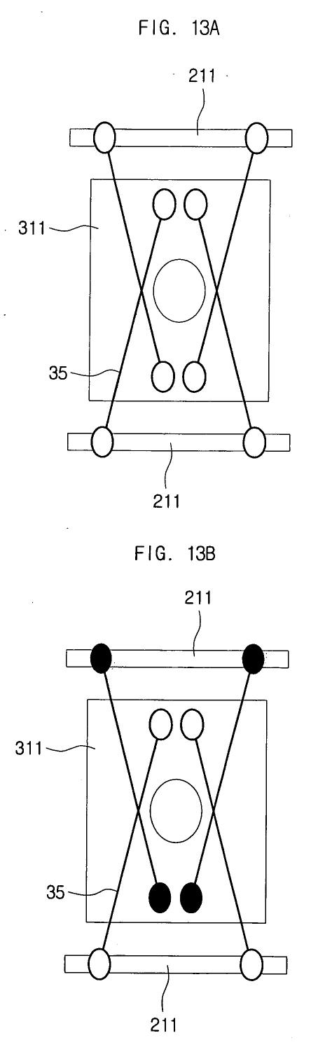

FIGS. 13a and 13b are schematic diagrams illustrating the suspension wires 35 positioned in an “XX” formation. In one pair of suspension wires 35, one end of each wire is soldered to the holder PCB 211 illustrated in FIG. 6, with the other end soldered to the bobbin PCB 311. In the other pair of suspension wires 35, both ends of each wire may either be soldered or bonded. The up/down and left/right spring coefficients of the suspension wires 35 having such formation are listed below in Table 4.

TABLE 4

| | diameter (mm) | | | | |
|---|---|---|---|---|---|
| | 0.09 | 0.1 | 0.11 | 0.12 | 0.13 |
| up/down spring coefficient (N/m) | 14.5 | 27.0 | 39.5 | 52.0 | 64.4 |
| left/right spring coefficient (N/m) | 87.4 | 90.1 | 96.5 | 110.8 | 119.0 |

As seen in Table 4, positioning the suspension wires 35 in an “XX” formation and securing the ends on the holder PCB's 211 provide lower values for the up/down spring coefficient and left/right spring coefficient, compared with those of the other embodiments disclosed above.

As set forth above, one an aspect of the present invention provides an actuator for a mobile terminal which uses suspension wires instead of the conventional flat spring, so that the manufacturing process may be simplified and the manufacturing cost may be reduced.

Another aspect of the invention provides an actuator for a mobile terminal which provides greater convenience in manufacture, as the suspension wires and coil may easily be connected.

Yet another aspect of the invention provides an actuator for a mobile terminal which provides high magnetic efficiency and low manufacturing cost, as quadrilateral magnets are used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An actuator for a mobile terminal comprising:
a holder;
magnets mounted inside the holder;
a coil mounted inside the holder and positioned on the inside of the magnets;
a bobbin joined with the coil and having a lens in its center; and
suspension wires, the ends of which are joined to the holder, bent at a particular angle to elastically press the bobbin.

2. The actuator for a mobile terminal, according to claim 1, wherein the magnets are quadrilateral magnets arranged inside the holder in a polygonal shape.

3. The actuator for a mobile terminal, according to claim 1, further comprising:
an outer yoke mounted inside the holder and arranged in a polygonal shape; and
an inner yoke positioned with a constant amount of displacement from the outer yoke and arranged in a polygonal shape in correspondence with the outer yoke,
wherein the magnets and the coil are positioned between the outer yoke and the inner yoke.

4. The actuator for a mobile terminal, according to claim 1, wherein the holder has a holder PCB, and the bobbin has a bobbin PCB connected with the coil;
and the holder PCB is joined with one end of the suspension wire;
and the bobbin PCB is joined with the other end of the suspension wire.

5. The actuator for a mobile terminal, according to claim 1, wherein the holder has a holder PCB, and the bobbin has a barrel holder connected with the coil;
and the holder PCB is joined with one end of the suspension wire;
and the barrel holder is joined with the other end of the suspension wire.

6. The actuator for a mobile terminal, according to claim 1, wherein the suspension wire is joined with the barrel holder by dipping.

7. The actuator for a mobile terminal, according to any one of claim 4 or claim 5, wherein the holder PCB is elastically deformable.

8. The actuator for a mobile terminal, according to claim 5, wherein the holder PCB comprises:
a binding part joined with the holder;
arms extending from both ends of the binding part in a particular length; and
an insertion part formed on one end of the arm;
wherein one end of the suspension wire is inserted into the insertion part and secured.

9. The actuator for a mobile terminal, according to claim 8, wherein the insertion part is a slot having a particular length.

10. The actuator for a mobile terminal, according to claim 8, wherein the insertion part is a groove open upwards.

11. The actuator for a mobile terminal, according to claim 5, wherein the holder PCB has an insertion part for securing one end of the suspension wire and is attached to the perimeter of the holder.

12. The actuator for a mobile terminal, according to claim 1, wherein the suspension wires are positioned in bilateral symmetry with respect to the bobbin.

13. The actuator for a mobile terminal, according to claim 12, wherein the suspension wires are positioned in an “11” formation.

14. The actuator for a mobile terminal, according to claim 12, wherein the suspension wires are positioned in a trapezoidal formation.

15. The actuator for a mobile terminal, according to claim 12, wherein the suspension wires are positioned in an “X” formation.

16. The actuator for a mobile terminal, according to claim 12, wherein the suspension wires are positioned in an “XX” formation.

17. The actuator for a mobile terminal, according to any one of claim 13 to claim 16, wherein one end of the suspension wire which does not require the flow of electricity is bonded.

18. The actuator for a mobile terminal, according to claim 1, wherein the holder has a quadrilateral shape.

19. The actuator for a mobile terminal, according to claim 3, wherein the outer yoke and the inner yoke are arranged in a quadrilateral shape.
